(19) United States
(12) Patent Application Publication
(10) Pub. No.: US 2009/0056196 A1
(43) Pub. Date: Mar. 5, 2009

(54) Diamond jig fish lure assembly, and components thereof

(76) Inventor: George P. Korteweg, Mystic, CT (US)

Correspondence Address: IRA S. DORMAN, 330 ROBERTS STREET, SUITE 200, EAST HARTFORD, CT, 06108, US

(21) Appl. No.: 11/897,687

(22) Filed: Aug. 31, 2007

(51) Int. Cl. A01K 85/02; A01K 85/00

(52) U.S. Cl. 43/42.39; 43/42.1; 43/42.28; 43/42.24

(57) ABSTRACT

A refurbished diamond jig fish lure consists of the jig body and separate tubular sleeve member and wing piece components mounted thereon. Tapered portions on the jig body, the sleeve member, and the wing piece cooperate to facilitate assembly and maintenance of the assembled unit.

### BACKGROUND OF THE INVENTION

Fish lures tend to become damaged and degraded during use, making refurbishment a very desirable prospect. It is well known moreover that a fish lure will usually be most effective if it simulates the natural food of an intended catch, not only in appearance (especially coloration and dominant physical characteristics) but also in movement through the water.

A wide variety of fish lures are described in the patent art, representative of which are the following United States patents:

| | |
|---|---|
| Des. No. 153,798 | Des. No. 429,310 |
| Des. No. 174,492 | Des. No. 456,059 |
| Des. No. 217,644 | No. 3,971,152 |
| Des. No. 222,058 | No. 4,307,531 |
| Des No. 243,954 | No. 4,922,646 |
| Des. No. 332,989 | No. 5,918,408 |
| Des. No. 406,310 | No. 5,987,805 |

U.S. Pat. No. 3,971,152 provides a molded fishing lure having an internal cavity for retaining a fish-attracting olfactory agent. The lure employs a lead head, which is inserted into an opening through a forward wall portion of an elastomeric body portion, the head having a knob which locks behind the forward wall of the body.

U.S. Pat. No. 4,307,531 provides a fishing lure that employs a simulated fish skin overlying a sheet of shiny material, the skin having iridescence and other general features of the particular fish species desired.

U.S. Pat. No. 4,922,649 provides a fishing lure comprised of an elongate, generally cylindrical “sculptured” body portion made of transparent or semi-transparent material, which terminates in a plurality of streamers forming a skirt portion. The body portion bears internal, and optionally external, longitudinal facets forming light-reflective and optically visible surfaces.

U.S. Pat. Nos. 5,918,408 and 5,987,805 provide fishing weights and devices that include dive- or rise-inducing structure, including pairs of wings that extend from a body.

### SUMMARY OF THE INVENTION

Despite the activity in the art evidenced by the foregoing, a need remains for means by which a fish lure can readily be refurbished to improve its appearance and performance; it is therefore a broad object of the present invention to provide a novel assembly for satisfying that need.

A more specific object of the invention is to provide such an assembly which can be employed to provide a fish lure that is so modified as to simulate a natural species or provide a unique form of fish bait.

A further object of the invention is to provide such an assembly in which a fish lure is so modified as to induce a desirable mode of movement through the water.

Additional objects of the invention are to provide an assembly having the foregoing features and advantages, which assembly is of incomplex construction, is inexpensive to manufacture, is readily and conveniently produced, and is effective for its intended purposes.

It has now been found that certain of the foregoing and related objects of the invention are attained by the provision of a fish lure assembly comprised of a jig member having an elongated body that is longitudinally tapered toward at least its forward end, but typically toward both opposite ends from a central region thereof, and including means for attaching a fish line adjacent the forward end and, usually, means for attaching a fish hook adjacent the rearward end. A compliant tubular sleeve member, separately formed and fabricated from a plastic material of low stretch modulus, is assembled in tight-fitting conformity with at least a major part of the length of the forward portion of the jig member body, and a separate wing piece is mounted adjacent the forward end of the jig member. The wing piece is comprised of a mounting portion, having a central axis along which an aperture extends, and a pair of wing elements that extend in generally opposite lateral directions with respect to the central axis, the aperture being dimensioned and configured to cause the wing piece to fit upon and engage a section on the forward end portion of the jig member body adjacent its forward end.

It should be appreciated that reference herein to the “forward” end and “rearward” end of the jig member body (and other components of the assembly) relate to the orientation of the assembly as it moves through the water, in use; thus, the fishing tackle will normally be attached to the forward end of the lure. Such references (including similar terminology) may or may not correspond to the forward end or rearward end of a species of natural bait that is simulated by the artificial lure.

In a specific, preferred embodiment of the invention, the jig member body will be formed with a multiplicity of longitudinally extending facets. There will typically be four such facets, extending along substantially the entire length of the jig member body; the orientation of the facets will usually impart a generally equilateral parallelogrammatic cross section to the body. The means provided on the assembly for attaching a line and a hook will desirably comprise eyelets secured to the jig member body, and the body itself will normally be fabricated from a heavy solid material (e.g., lead or stainless steel), albeit other materials, and filled or unfilled bodies, may also be employed.

The tubular sleeve member will most desirably be formed with a taper at one end, which taper corresponds at least generally, if not substantially, to the longitudinal taper of the jig member in the direction of the forward end thereof; as produced, the tubular sleeve member will typically have a taper of about 3° to 10° at the “one” end thereof, taken with reference to a longitudinal axis of the sleeve member. The aperture in the wing piece mounting portion will most desirably also be tapered so as to mate with a corresponding section of the body portion. It may however be round, oval, or of any other shape that enables it to engage the corresponding part of the jig member body, given the elasticity and conformability of the material from which it is made.

Other objects of the invention are attained by the provision of a fish lure assembly comprised of a jig member and a separately formed, complaint tubular sleeve member assembled in tight-fitting conformity with the forward end portion of the jig member body. A tapered portion of the sleeve member will correspond substantially to the longitudinal taper of the forward portion of the jig member body, and the material of the sleeve member will be stretched by the jig member body so as to engage it while resisting further deformation.

The tubular sleeve member will, as formed, usually be of circular cross section along its entire length, and will be flaccid and devoid of internal structure. It will advantageously be fabricated from a plastic material having an elongation value, or modulus, of 100 to 300 percent, as determined by ASTM method D-638, and in most instances it will be formed with an opening through which the fish line attaching means (and often part of the jig member body, as well) extends.

In the most preferred embodiments, the tubular sleeve member will be provided with at least one characteristic for simulating one or more features of live fish bait. That characteristic will desirably be coloration, the simulation of eyes, the simulation of fins, and/or the simulation of tentacles. In one specific form, the tubular sleeve member will be made with eye and tentacle characteristics, to simulate a squid; the sleeve member may also have a vertical tail fin feature, to simulate a bait fish, and other catch-attractive characteristics may additionally or alternatively be incorporated into the sleeve member.

Still other objects of the invention are attained by the provision of a fish lure assembly comprised of a jig member, as hereinabove and hereinafter described, and a separate wing piece mounted upon the jig member body adjacent the forward end thereof. The wing piece will be comprised of a mounting portion having a central axis, along which an aperture extends, and a pair of wing elements extending in generally opposite lateral directions with respect to the central axis; the wing elements might simulate the caudal fins of a squid. In such embodiments, the aperture in the mounting portion will be dimensioned and configured so as to cause the wing piece to fit upon, and fixedly engage, a portion of the jig member body adjacent its forward end.

As noted above, the aperture in the wing piece will desirably (but not necessarily) be formed to mate with the engaging portion of the jig member body. More specifically, the aperture of the wing piece will desirably be tapered to match the taper of the forward end portion of the jig member body (being, for example, of generally equilateral parallelogrammatic cross section), such that the wing piece will unidirectionally fixedly engage the jig member body portion.

In any event, the wing piece will advantageously be molded from a plastic material of low Durometer value and relatively high elongation, to permit it to resiliently deform and elastically engage the jig member body portion. The plastic material may, more particularly, have a Durometer value of about 3 to 65, on the Shore A scale, and a percent elongation of about 300 to 1,000.

### BRIEF DESCRIPTION OF THE DRAWINGS

FIG. 1 is a perspective view of a three-component fish lure assembly embodying the present invention, a section of the tubular sleeve component being broken away to expose the jig member body therewithin;

FIG. 2 is a perspective view of a two-component fish lure embodying the present invention, the assembly additionally including an attached fishhook;

FIG. 3 is a cross-sectional view taken along line 3-3 in FIG. 2;

FIG. 4 is a perspective view of the tubular sleeve component employed in the assembly of the foregoing Figures, taken from one side;

FIG. 5 is a forward end view of the sleeve component;

FIG. 6 is a perspective view of the wing piece employed in the assembly of FIG. 1;

FIGS. 7 and 8 are forward and rearward end views, respectively, of the wing piece shown in FIGS. 1 and 6;

FIG. 9 is a side view of a further style of sleeve element component suitable for use in assemblies embodying the present invention; and

FIG. 10 is a perspective view of an alternative form of jig member suitable for use in lure assemblies embodying the invention.

### DETAILED DESCRIPTION OF THE PREFERRED AND ILLUSTRATED EMBODIMENTS

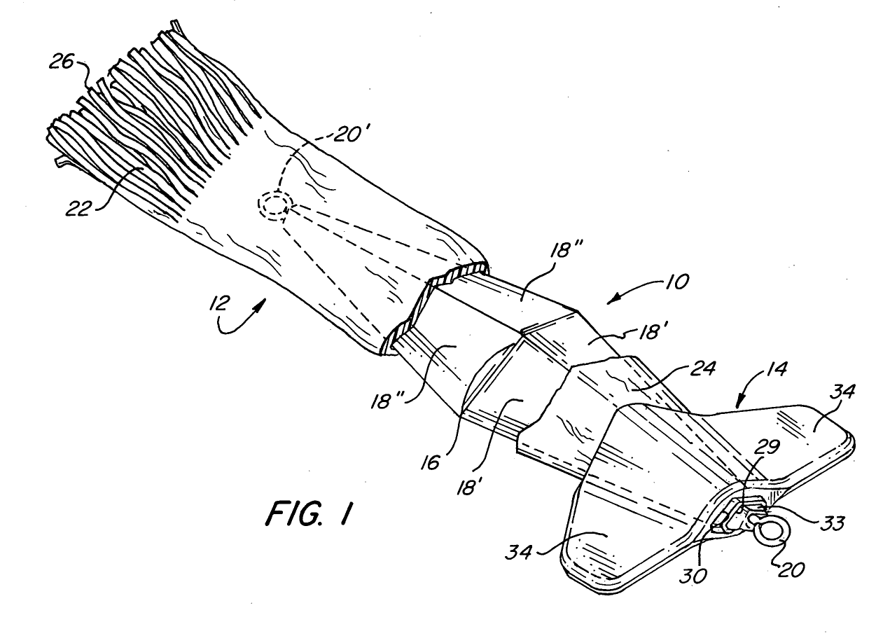

Turning initially to FIG. 1 of the drawings, therein illustrated is a fish lure assembly embodying the present invention and consisting of three components; i.e., a diamond jig body, a tubular sleeve member, and a wing piece, generally designated, respectively, by the numerals 10, 12 and 14. The diamond jig body 10 is a standard commercial artificial fish lure, normally made from a heavy metal, such as lead or stainless steel, and weighting about 4 to 16 ounces to function as a sinker for taking the lure to a level deeply below the water surface.

The body 10 of a diamond jig is tapered (generally at an angle of 3° to 10°, relative to its longitudinal centerline) in both the forward and rearward directions from a central region 16, and is formed with four facets 18 that extend along at least substantially the entire length of the body 10. Because of the taper, each facet 18 may be considered to consist of a forward facet element 18′ and a rear-ward facet element 18″, defining forward and rearward portions of the jig body, respectively, extending from the intersections of the facet elements at the central region 16. As is perhaps best shown (in this Figure) by the exposed forward end, the orientations of the facets 18 impart an equilateral parallelogrammatic cross section to the body 10, taken at transverse planes along its entire length.

At least as manufactured, the facets 18 of a diamond jig may be made reflective for the purpose of increasing visibility and the likelihood of attracting fish. The level of reflectance quickly diminishes however with use (because of fouling, marring, and the like), and in any event reflectivity is of dubious value in deep-water fishing situations due to the deficiency of ambient light (i.e., at depths of perhaps 20 feet or more, where desirable game fish such as cod reside, it is believed that there can be little or no appreciable light reflection).

The body 10 of the jig carries eyelets 20, 20′ at the forward and rearward ends, respectively, which are typically integrated into the metal. Needless to say, the forward eyelet 20 serves for attachment of the line from the fishing tackle, and the rearward eyelet 20′ serves for attachment of a hook (which may of course be of any suitable form, and comprised of single or multiple elements); it may alternatively be found desirable to integrate the hook, by casting the metal about its shank in the course of forming the body.

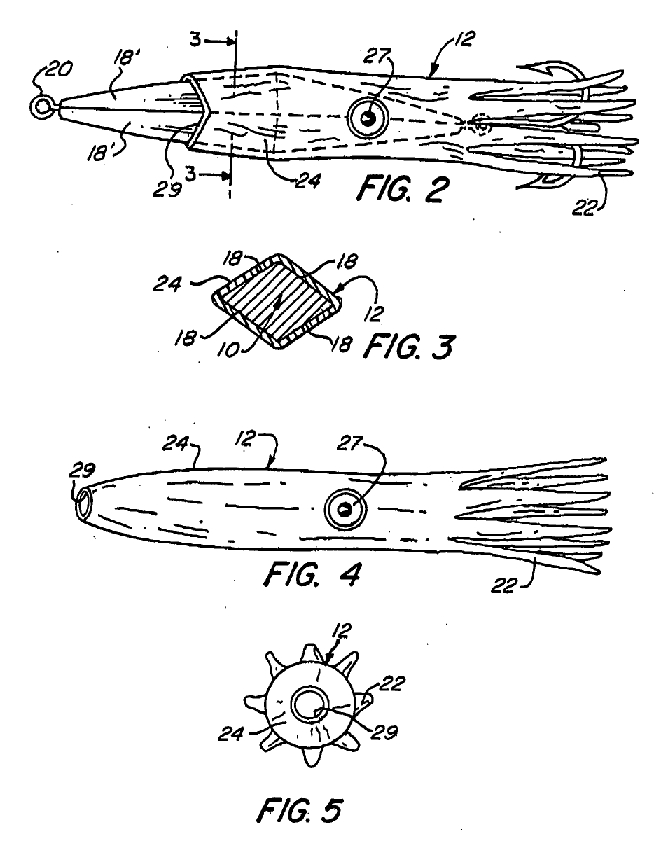

With additional specific reference now to FIGS. 2-5, the tubular sleeve element 12 will, as produced, normally be of circular cross section (albeit tending to be deformed under its own weight toward an elliptical shape, as a free-standing article, due to flaccidity of the material of fabrication and the absence of internal reinforcing structure or elements). The sleeve may desirably have a skirt portion 22 at its rearward end, comprised of strands or strips of material providing tentacle-simulating elements, which may be integrally formed into the sleeve or may be produced by longitudinal slitting of the sleeve material.

Most importantly, however, the sleeve member will be formed with a tapered forward end portion 24 so as to enable assembly, in tight-fitting conformity, with the correspondingly tapered forward end portion of the jig member body (as pointed out above, the taper angle will usually be substantially the same, but that is not necessarily so). The length over which the sleeve member and body portion interengage tightly must be substantial, and should be at least about one inch (2.54 centimeters).

As noted above, the stretch modulus and Durometer value of the material from which the sleeve member is produced (usually, PVC) should be such that the tapered end portion of the jig member body 10 will stretch the tapered portion 24 of the sleeve member 12 during application (i.e., by insertion of the jig member forward end portion into the larger diameter, open end 26 of the tubular sleeve member), so as to cause the sleeve member to elastically engage the jig member body while resisting further deformation (i.e., without exceeding the elastic limit of the sleeve material); in assembly, the end of the jig body protrudes through the smaller opening 29 in the forwardly oriented end of the sleeve 12.

As will be appreciated by those skilled in the art, the Durometer and stretch modulus values that will produce the foregoing condition will depend upon a number of factors, including not only composition but also the thickness of the sleeve material and the shape, character, and surface condition of the jig member body; thus, a marred, pitted, or dirty body surface will of course present a higher level of frictional resistance to assembly (and disassembly) than will a body having a smooth (or indeed shiny) and uniform surface. The inherent characteristics of the sleeve member must be such that (taken with the particular jig member involved) it can readily be drawn upon the body to a suitable position (and not therebeyond, without excessive applied force or overstretching), and that it will remain in place during normal use for a practical period of time. The plastic materials employed must at the same time exhibit suitable levels of strength and toughness to provide adequate durability and resistance to damage.

As depicted in FIGS. 2 and 4, the tubular sleeve member 12 is not only formed with a slitted skirt portion 22 but it is also provided with elements 27 (produced by printing, attachment, or other suitable means) simulating eyes (only one of which is visible). Albeit the body may be transparent, translucent or opaque, in most instances it will be desirable to incorporate a dye or pigment into the material of fabrication so as to increase the visual attractiveness of the lure to the intended catch. Selected colorations may be employed to attract a particular fish, either by simulating its natural food (for example, a squid-simulating member may be colored red) or by providing other visual stimulation. Especially for use in low-light environments, moreover, the sleeve member may incorporate an iridescent or fluorescent dye or pigment to utilize, to greatest benefit, the available ambient light; a luminescent dye or pigment (charged or excited, for example, using the beam of a flashlight just before use) may also be employed. It should be appreciated that the same decorating and coloring considerations are, in general, similarly applicable to fabrication of the wing piece 14, and that, as used herein, the references to “coloration” are to be broadly construed to include not only the dyes and pigments referred to but also, for example, reflective particles, flakes, and the like.

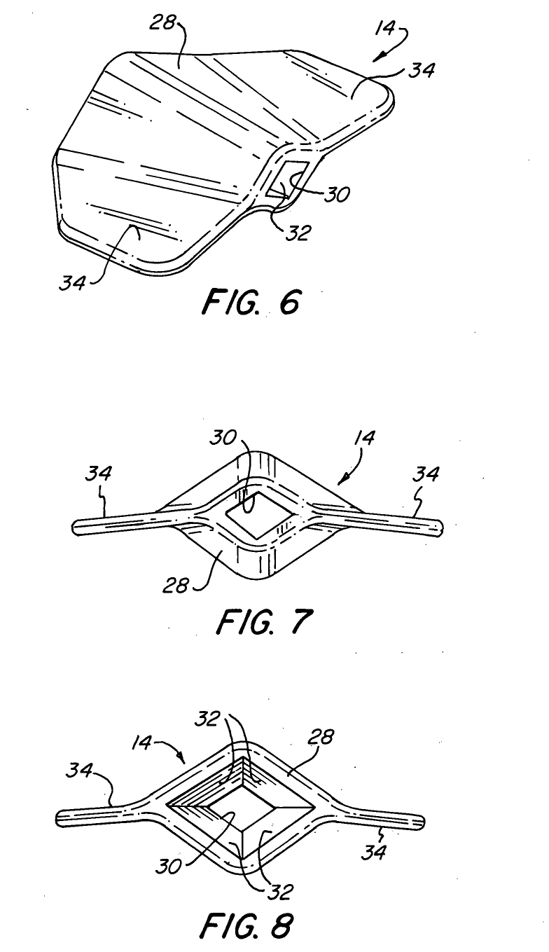

With further particular reference now to FIGS. 6-8 of the drawings, the wing piece 14 is seen to comprise a mounting portion 28 through which extends, along its central axis, an aperture 30 of equilateral parallelogrammatic cross section, defined by four forwardly tapered surfaces 32. The aperture 30 serves of course to receive the section 33 of the jig member body 10 adjacent its forward end (seen in FIG. 1 to be protruding through an opening 29 in the sleeve member 12), undirectionally fixedly engaging the wing piece 14 against rearward displacement on the body 10. Optimally (and irrespective of the form of its aperture), the wing piece is fabricated from a plastic material (e.g., a molded vinyl plastisol, or PVC) that resiliently deforms and elastically and frictionally engages the under-lying jig member body section.

The pair of wing elements 34 are integrally formed, as a single piece, with the mounting portion 28 and extend in generally opposite lateral directions therefrom. The structure and orientation of the wing elements 34 may be such as to promote any of a variety of movements of the lure through the water, inducing ascent, diving or, indeed, mere deviation (of a predictable or random nature) from any regular course.

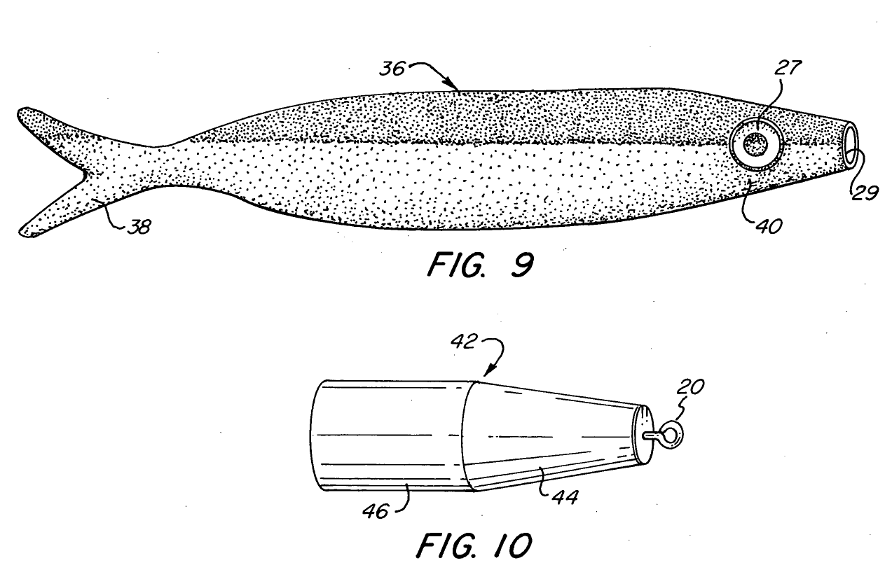

Turning now to FIG. 9 of the drawings, therein illustrated is a tubular sleeve member, generally designated by the numeral 36, suitable for assembly with a diamond jig body (such as the body 10, previously described) and having the necessary structural features hereinabove set forth. As can be seen, the sleeve member 36 simulates a fish having a dorsal side that is more darkly colored than its underside, and having an eye 27 near its forward end and a vertical tail fin 38; the forward end portion 40 of the sleeve member 36 is tapered for conformity with the jig member body, as previously described.

Turning finally to FIG. 10, therein shown is a jig member body, generally designated by the numeral 42, which represents one of many alternative forms that the jig member body could take. As can be seen, the body 42 is of circular cross section, taken at all transaxial planes, and consists of a frustoconical forward portion 44 and a cylindrical rearward portion 46. If used with the sleeve member 36 of FIG. 9, for example, the forward end portion 40 thereof would conformably engage the frustoconical portion 44 of the body 42.

It will be appreciated that many other variations can be made in the fish lure assembly herein described, without departure from the concepts underlying the invention. For example, in those embodiments in which the jig member body is formed with facets, as few as three, and perhaps as many as nine or more, may be provided. Moreover, while the present disclosure focuses upon the provision of an assembly that includes the jig member body, the invention could desirably be implemented by the provision of a kit, for refurbishing such a body, comprised of a tubular sleeve member and/or a wing piece having the unique construction and features described herein. The components of the assembly described might also find application in OEM fish lure production.

Thus, it can be seen that the present invention provides a novel assembly for readily refurbishing a fish lure to improve its appearance and performance. The assembly can be employed to provide a fish lure that is so modified as to simulate a natural species of fish bait, or to provide a lure of unique form or character, and/or to induce a desirable mode of movement through the water. The assembly of the invention is of incomplex construction, is inexpensive to manufacture, is readily and conveniently produced, and is effective for its intended purposes.

Having thus described the invention, what is claimed is:

1. A fish lure assembly comprised of a jig member having an elongated body with a forward end and an opposite rearward end, and including means for attaching a fish line adjacent said forward end and means for attaching a fish hook adjacent said rearward end, said jig member body being longitudinally tapered so as to provide at least a tapered forward end portion thereon;
a separately formed, compliant tubular sleeve member assembled in tight-fitting conformity with said jig member body along at least a major part of the length of said forward end portion thereof, said sleeve member being fabricated from a plastic material of low stretch modulus; and
a separate wing piece mounted upon said jig member body adjacent said forward end thereof, said wing piece being comprised of a mounting portion, having a central axis along which an aperture extends, and a pair of wing elements extending in generally opposite lateral directions with respect to said central axis, said aperture being dimensioned and configured to cause said wing piece to fit upon and engage a section on said forward end portion of said jig member body adjacent said forward end thereof.

2. The assembly of claim 1 wherein said body is longitudinally tapered toward both of said opposite ends from a central region.

3. The assembly of claim 1 wherein said jig member body is formed with a multiplicity of facets extending longitudinally thereon.

4. The assembly of claim 3 wherein there are four of said facets extending along substantially the entire length of said jig member body, and wherein said jig member body is of generally equilateral parallelogrammatic cross section along substantially the entire length thereof.

5. The assembly of claim 1 wherein each of said attaching means comprises an eyelet secured to said jig member body.

6. The assembly of claim 1 wherein said jig member body is fabricated from a heavy solid material.

7. The assembly of claim 1 wherein said tubular sleeve member is formed with a taper at one end, said taper corresponding generally to the longitudinal taper of said forward end portion of said jig member body.

8. The assembly of claim 7 wherein said tubular sleeve member, as produced, has a taper of about 3° to 10° at said one end thereof, taken with reference to a longitudinal axis of said sleeve member.

9. The assembly of claim 1 wherein said section of said jig member body adjacent said forward end thereof is tapered, and wherein said aperture in said wing piece mounting portion is tapered to mate with said body section.

10. A fish lure assembly comprised of a jig member having an elongate body with a forward end and an opposite rearward end, and including means for attaching a fish line adjacent said forward end, said jig member body being longitudinally tapered so as to provide at least a tapered forward end portion thereon; and
a separately formed, complaint tubular sleeve member assembled in tight-fitting conformity with said jig member body along at least a substantial part of the length of said forward end portion thereof, said sleeve member being fabricated from a plastic material of low stretch modulus and being formed with a tapered portion at one end, the taper of said tapered portion corresponding generally to the longitudinal taper of said forward end portion of said of said jig member body, said sleeve member tapered portion being stretched by said forward end portion of said jig member body to elastically engage said jig member body and resist further deformation.

11. The assembly of claim 10 wherein, as produced, said tubular sleeve member is of circular cross section along its entire length, and wherein said substantial part of the length of said forward end portion of said jig body is at least one inch.

12. The assembly of claim 10 wherein said tubular sleeve member is flaccid and devoid of internal structure, and wherein said forward end portion of said jig member body is defined by a plurality of longitudinally continuous surfaces and is devoid of engaging elements lying above or below said continuous surfaces.

13. The assembly of claim 10 wherein said plastic material from which said tubular sleeve member is formed has an elongation value of 100 to 300 percent, as determined by ASTM method D-638.

14. The assembly of claim 10 wherein said taper of said forward end portion of said jig member body, and said taper of said one end of said tubular sleeve member, are substantially the same and have a value of about 3° to 10° taken with reference to the longitudinal axes thereof.

15. The assembly of claim 10 wherein said tubular sleeve member has an opening at said one end through which said forward end portion of said jig member protrudes and through which said means for attaching a fish line extends.

16. The assembly of claim 10 wherein said tubular sleeve member is made with at least one characteristic for simulating at lest one feature of live fishing bait.

17. The assembly of claim 16 wherein said at least one characteristic is selected from the group consisting of coloration, eyes, fins, and tentacles.

18. The assembly of claim 17 wherein said tubular sleeve member is made with eye and tentacle characteristics to simulate a squid.

19. The assembly of claim 15 wherein a luminescent, fluorescent, or iridescent dye or pigment is incorporated on or into said plastic material from which said sleeve member is fabricated.

20. A fish lure assembly comprised of a jig member having an elongate body with a forward end and an opposite rearward end, and including means for attaching a fish line adjacent said forward end, said jig member body being longitudinally tapered so as to provide at least a tapered forward end portion thereon; and
a separate wing piece mounted upon said jig member body adjacent said forward end thereof, said wing piece being comprised of a mounting portion, having a central axis along which an aperture extends, and a pair of wing elements extending in generally opposite lateral directions with respect to said central axis, said aperture being dimensioned and configured to cause said wing piece to fit upon, and fixedly engage, a section of said jig member body adjacent said forward end thereof.

21. The assembly of claim 20 wherein said aperture of said wing piece is tapered to match the taper of said forward end section of said jig member body; and wherein forward end section of said jig member body, and said wing piece aperture, are of generally equilateral parallelogrammatic cross section, said wing piece unidirectionally fixedly engaging said jig member body section.

22. The assembly of claim 20 wherein said wing piece is molded from a plastic material of such Durometer value and elongation value as to permit said wing piece to resiliently deform and elastically engage said jig member body section.

23. The assembly of claim 22 wherein said plastic material from which said wing piece is molded has a Durometer value of about 3 to 65 on the Shore A scale, and an elongation of about 300 to 1,000 percent.

24. The assembly of claim 20 wherein said jig member is fabricated from a heavy solid material and has a weight of about 4 to 16 ounces.
